(19) United States
(12) Patent Application Publication
(10) Pub. No.: US 2019/0178466 A1
(43) Pub. Date: Jun. 13, 2019

(54) OPTICAL STRUCTURE OF LED WALL LAMPS WITH ENHANCED EFFECTIVE OUTPUT LIGHT

(71) Applicant: Sundopt Led Lighting Co., Ltd., Shenzhen (CN)

(72) Inventors: Fangyi Weng, Shenzhen (CN); Guoxin LI, Shenzhen (CN)

(21) Appl. No.: 15/888,730

(22) Filed: Feb. 5, 2018

(30) Foreign Application Priority Data
Dec. 12, 2017 (CN) 201721725394.2

(51) Int. Cl. F21V 3/02; F21S 8/00; F21V 31/00; F21V 17/12; F21V 17/06; F21V 3/06

(52) U.S. Cl. CPC F21V 3/02; F21S 8/033; F21V 31/005; F21Y 2115/10; F21V 17/06; F21V 3/061; F21V 17/12

(57) ABSTRACT

The utility model disclosed herein is an optical structure of LED wall lamps with enhanced effective output light. The optical structure is arranged on the shell of the LED wall lamp. The LED wall lamp comprises a bottom shell, a radiator lamp body, a light source module and a surface cover. The bottom shell is connected with the radiator lamp body. The optical structure of the LED wall lamp of this invention enables the ratio of the effective output light of 0-90 degrees of the lamp be more than 90% of the light output of the whole lamp, the light efficiency of the whole lamp is larger than or equal to 130 lm/w, and the light efficiency of 0-90 degrees is larger than or equal to 120 lm/w, and the high light efficiency of the effective light part of 0-90 degrees is perfectly achieved; The high requirement standard that the light efficiency of the effective light part of 0-90 degrees is greater than or equal to 120 lm/w, which is in the DLC energy efficiency high level standard, is satisfied. The competitiveness and the energy-saving effect of the product are improved.

### TECHNICAL FIELD

The disclosure herein relates to the technical field of LED lamps, and particularly relates to an optical structure of LED wall lamps with enhanced effective output light.

### BACKGROUND

There are disadvantages for existing LED wall lamps: The light efficiency of existing LED wall lamps are low, and the ratio of the effective light of 0-90 degrees is small, which is generally about 77%; This leads to that the light efficiency of the product in the range of 0-90 degrees is low, the overall light efficiency of wall lamps on the market is about 100-110 lm/w, and the light efficiency of 0-90 degrees is about 77-85 lm/w.

The reason why there are disadvantages for existing LED wall lamps is: Due to the limitation of the structure of a lamp, in order to make the light emitted from the lamp to irradiate to the ground as much as possible, the lamp boards in the LED wall lamps on the market may incline towards the ground, so that the ratio of the luminous flux for the region of 0-90 degrees is increased. Then, if the lamp board incline more to the ground, a portion of the light can be emitted to the radiator and be absorbed, although the ratio of 0-90 degrees is increased, so that the light emitting efficiency of the whole lamp is reduced, and the light efficiency of 0-90 degree is also reduced accordingly.

### SUMMARY

In order to meet the requirement that an LED wall lamp has high light efficiency and the ratio of the light for the region of 0-90 degrees is more than 90%, an optical structure of LED wall lamps with enhanced effective output light is put forward.

To solve the above technical problem, this invention puts forward a scheme as follows: An optical structure of LED wall lamps with enhanced effective output light is arranged on the outer shell of the LED wall lamp. The LED wall lamp comprises: a bottom shell, a radiator lamp body, a light source module and a surface cover. The bottom shell is connected with the radiator lamp body. The left side surface and the right side surface of the radiator lamp body are triangular surfaces. The two triangular surfaces are connected with rectangular surfaces. A mounting groove is arranged on one of the rectangular surfaces. A light source module is installed in the installation groove. The light source module comprises a PCB lamp board. LED lamp beads are arranged on the PCB lamp board. The LED lamp beads are affixed on the PCB lamp board and are aligned as multi-row horizontal straight lines. A reflecting cover is arranged on the PCB board. The reflecting cover shields the PCB lamp board except the LED lamp beads. The upper reflecting surface and the lower reflecting surface of the reflecting cover can let the emitting light, which is reflected by the LED lamp beads, be reflected with directions in the range of 0-90 degrees;

The reflecting cover and the light source module are fixed on the radiator lamp body through a third screw to form a heat dissipation assembly, the pressing piece affixes the glass cover and the waterproof rubber ring on the radiator, the second screw passes through the middle hole of the pressing piece to lock the pressing piece on the radiator lamp body, the surface cover covers the pressing piece, which is fixed on the radiator through a meter screw located on a side;

An inclination angle of 5-30 degrees is arranged between the bottom surface of the installation groove and the radiator lamp body, and the distance between the bottom surface and the radiator lamp body is increased from top to bottom in sequence;

The reflecting cover has a plurality of rows of trapezoid-shaped grooves. The upper end and the lower end of the trapezoid-shaped groove are holes. The angle between the upper inclined side surface and the bottom surface is smaller than the angle between the lower inclined side surface and the bottom surface. The left side surface and the right side surface are inclined planes.

Further, the bottom shell is a square body. The upper end has an opening. The radiator lamp body covers the opening and is connected through a third screw. The radiator lamp body comprises two side surfaces which are triangular side plates, and two square inclined planes which are connected with the two triangular side plates. A square opening is arranged on the bottom surface of the radiator lamp body. The bottom surface of the radiator lamp body is connected with an opening in the upper end of the bottom shell. An installation groove is arranged on one inclined surface of the radiator lamp body. A light source module is arranged on the inner bottom surface of the installation groove. The light source module is covered by the reflecting cover. The reflecting cover and the light source module are fixed on the installation groove of the radiator lamp body through a third screw, to form a heat dissipation assembly.

Further, a waterproof frame is arranged at the joint between the radiator lamp body and the bottom shell.

Further, the light source module comprises a light source plate and a plurality of LED light sources. The LED light sources are affixed on the light source plate and are aligned as multi-row horizontal straight lines.

Further, the reflecting cover is arranged on the PCB board of the light source module. The reflecting cover shields the PCB board body except the LED lamp. It has a triangular bulge, and the triangular bulge is arranged in the light-emitting region of the LED lamp. Its angle is such that the light emitted by the LED lamp can be reflected, and is such that the parallel light beam formed after the reflection of the light which has the angle of 0-120 degrees and which is emitted from LED lamp, is in the range of 0-90 degrees.

Further, the glass cover is protruded on the inclined surface of the radiator lamp body. The two side surfaces are triangular. The two upper surfaces are inclined planes. The whole outer surface is provided with a rhombohedral concave-convex pattern.

Further, the rhombohedral concave-convex lines are all transversely arranged on the glass surface cover.

Further, the glass mask can be replaced by a PC mask.

Compared to the existing technologies, the advantages of this invention are: The optical structure of the LED wall lamp of this invention enables the ratio of the effective light of the lamp for 0-90 degrees be more than 90% of the light output of the whole lamp, the light efficiency of the whole lamp be larger than or equal to 130 lm/w, the light efficiency of 0-90 degrees be larger than or equal to 120 lm/w, perfectly achieving the high light efficiency of the part of the effective light for 0-90 degrees; The high level requirement in the DLC energy efficiency advanced standard, which is that the light efficiency of the part of the effective light for 0-90 degrees is greater than or equal to 120 lm/w, is met, improving the competitiveness and the energy-saving effect of the product.

### BRIEF DESCRIPTION OF FIGURES

FIG. 1 shows an assembly diagram for an LED wall lamp according to this invention;

FIG. 2 shows an exploded view for an LED wall lamp according to this invention;

FIG. 3 schematically shows a diagram for the light emitting of a small-angle PCB board of an LED wall lamp according to this invention;

FIG. 4 schematically shows a diagram for the light emitting of a large-angle PCB board of an LED wall lamp according to this invention;

FIG. 5 schematically shows a diagram for the light emitting diagram of the LED wall lamp which is additionally equipped with a reflecting cover and the rest of which is in FIG. 4.

### DETAILED DESCRIPTION

Preferred embodiments of this invention are described in detail below with reference to the attached drawings. Thus, the advantage and the characteristics of this invention can be easily understood by those skilled in the art, so that the protection scope of this invention is more clearly defined.

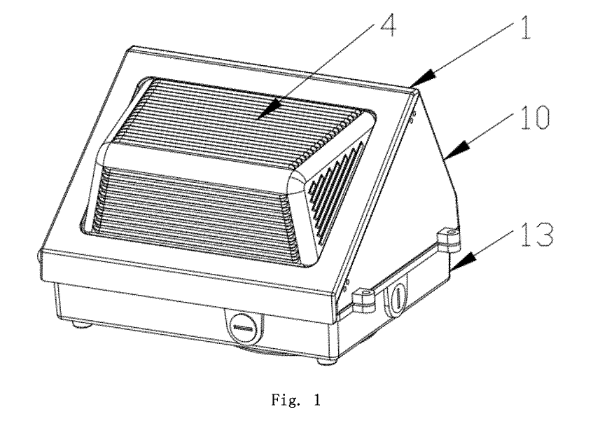

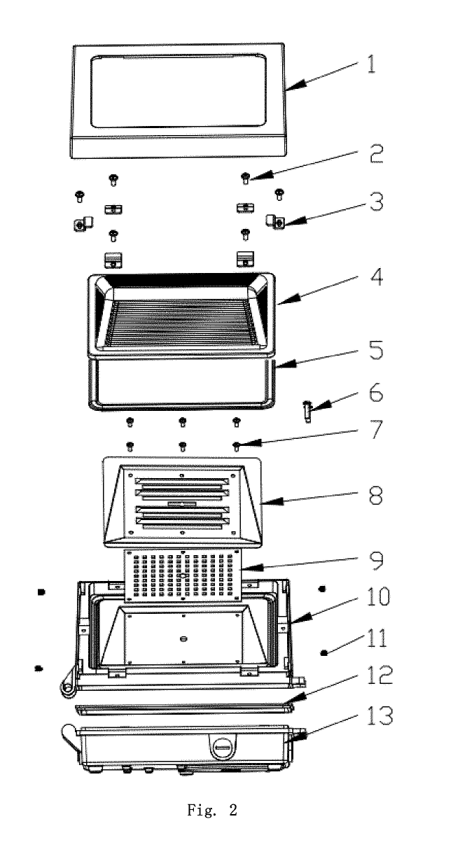

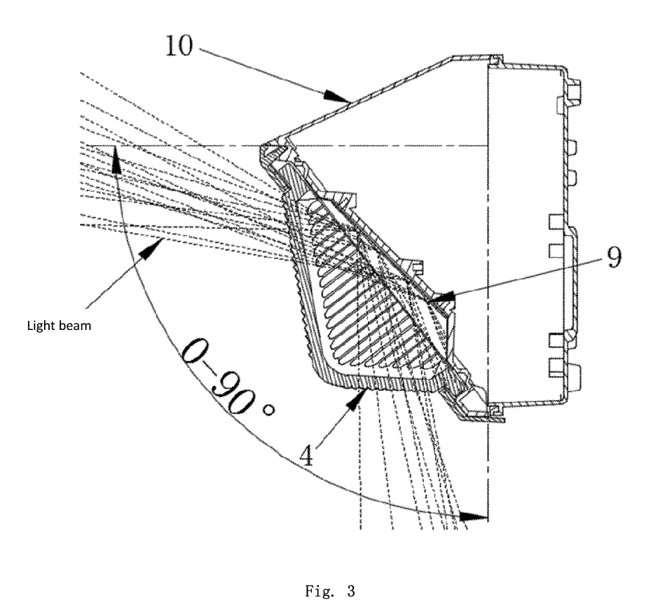

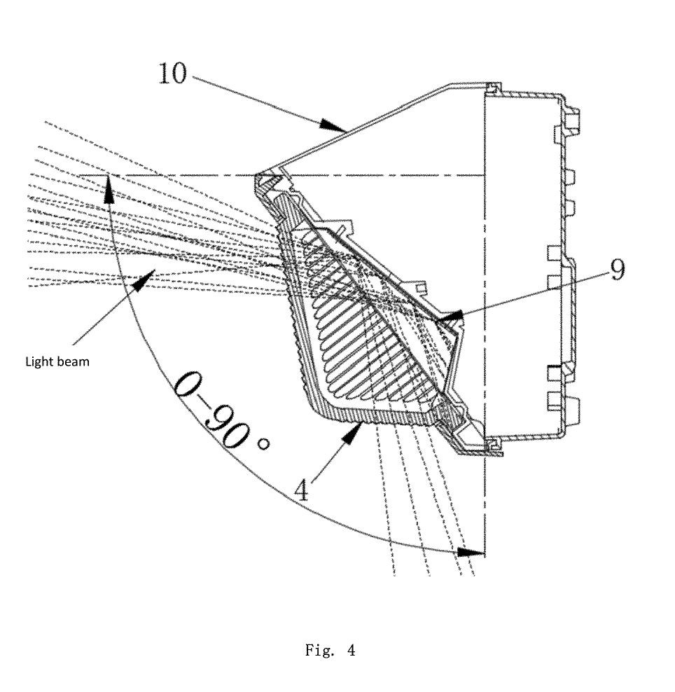

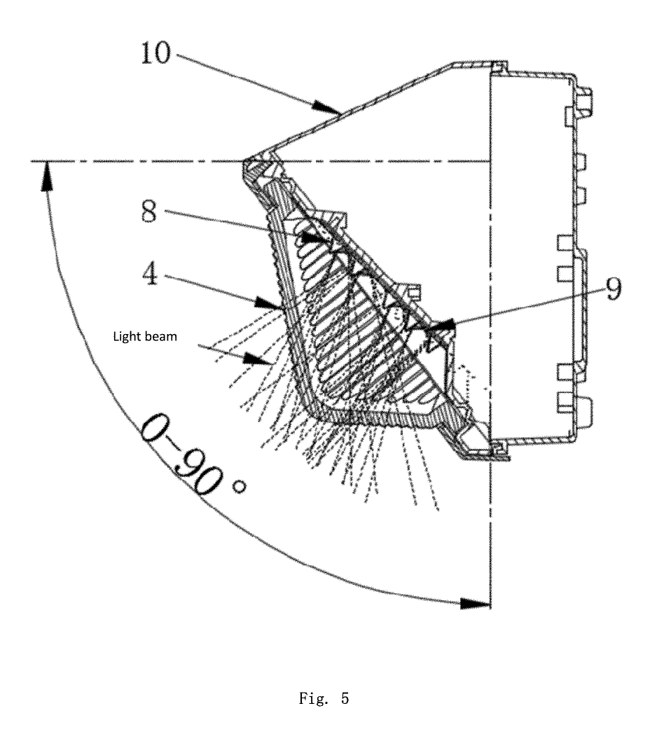

Please refer to FIG. 1-5. An optical structure of LED wall lamps of this invention, which is with enhanced effective output light, is arranged on the outer shell of the LED wall lamp. The LED wall lamp comprises a bottom shell 13, a radiator lamp body 10, a light source module 9, and a surface cover 1. The bottom shell 13 is connected with the radiator lamp body 10. The left side surface and the right side surface of the radiator lamp body 10 are triangular surfaces. The two triangular surfaces are connected with rectangular surfaces. An installation groove is arranged on one of the rectangular surfaces. A light source module 9 is arranged in the installation groove, wherein the light source module 9 comprises a PCB lamp board, LED lamp beads are arranged on the PCB lamp board, the LED lamp beads are affixed on the PCB lamp board and are aligned as multi-row horizontal straight lines, a reflecting cover 8 is arranged on the PCB board, the reflecting cover 8 shields the PCB lamp board except the LED lamp beads, the upper reflecting surface and the lower reflecting surface of the reflecting cover 8 enables the output light, which is reflected by the LED lamp beads, be reflected with the directions in the range of 0-90 degrees;

The reflecting cover 8 and the light source module 9 are fixed on the radiator lamp body 10 through a third screw 7 to form a heat dissipation assembly, the pressing piece 3 affixes the glass mask 4 and the waterproof rubber ring 5 on the radiator, the second screw 2 passes through the middle hole of the pressing piece 3 to lock the pressing piece 3 on the radiator lamp body 10, the surface cover 1 covers the pressing piece 3, which is fixed on the radiator 10 through set screw 11 which is located on a side;

The angle between the bottom surface of the mounting groove and the radiator lamp body 10 is set as 5-30 degrees, and the distance from the bottom surface to the radiator lamp body 10 is increased from top to bottom in sequence;

A plurality of rows of trapezoid-shaped grooves are arranged on reflecting cover 8, the upper bottom and the lower bottom are hole openings, the angle between the upper inclined side surface and the bottom surface is smaller than the angle between the lower inclined side surface and the bottom surface, the left side surface and the right side surface are inclined planes.

Preferred embodiment: the bottom shell 13 is a square body. The upper end has an opening. The radiator lamp body 10 covers the opening and is connected through a third screw 6. The radiator lamp body 10 comprises: two side surfaces which are triangular side plates, and two square inclined planes which are connected with the two triangular side plates. A square hole is arranged in the bottom surface of the radiator lamp body 10. The bottom surface of the radiator lamp body 10 is connected with an opening in the upper end of the bottom shell 13. An installation groove is arranged in one inclined surface of the radiator lamp body 10. A light source module 9 is arranged on the bottom surface of the installation groove. The reflecting cover 8 covers the light source module 9. The third screw 7 affixes the reflecting cover 8 and the light source module 9 on the installation groove of the radiator lamp body 10, to form a heat dissipation assembly.

Preferred embodiment: A waterproof frame 12 is arranged at the joint between the radiator lamp body 10 and the bottom shell 13.

Preferred embodiment: The light source module 9 comprises a light source plate and a plurality of LED light sources. The LED light sources are affixed on the light source plate and are aligned as multi-row horizontal straight lines.

Preferred embodiment: The reflecting cover 8 is installed on the PCB board of the light source module 9. The reflecting cover 8 shields the PCB board body except the LED lamp. It has a triangular bulge. The triangular bulge is arranged in the light-emitting region of the LED lamp. The angle is such that the light emitted by the LED lamp can be reflected, and is such that the parallel light beam, formed after the reflection of the light of 0-120 degrees which is emitted by LED lamp, is within the range of 0-90 degrees.

Preferred embodiment: The glass mask 4 is protruded on the inclined surface of the radiator lamp body 10. Its two side surfaces are triangular. The two upper surfaces are inclined surfaces. The whole outer surface is provided with a rhombohedral concave-convex pattern.

Preferred embodiment: The rhombohedral concave-convex lines are all transversely arranged on the glass mask 4.

Preferred embodiment: The glass mask 4 can be replaced by a PC mask. The working principle for the LED wall lamp of this invention: The LED lamp beads are affixed on a PCB lamp board and are aligned as multi-row horizontal straight lines. Through the optical precision design, according to the principle of the light emitted by LED lamp bead in the way of 120 degrees and the light emitted by LED light source in the way of straight line irradiation, when the light emitted upwards by LED lamp beads irradiates the light-reflecting cover which highly reflects light, the reflecting downwards is performed, so that more light irradiates in the range of 0-90 degrees. That the light reflecting cover with high reflection controls the light emitting direction is carried out for each row of LED lamp beads, and the high-light-transmittance glass lampshade or the PC lampshade is provided, so that the light can be fully transmitted out, more light of the product can be emitted downwards, the ratio of the light efficiency of 0-90 degrees is larger than 90%, the light efficiency of the effective light in the range of 0-90 degrees of the whole lamp is enhanced.

Existing LED wall optical structures only comprise a glass lampshade or a PC lampshade. In our design, while there is a glass lampshade or a PC lampshade, a high-reflection reflecting cover to control the light emitting angle of the lamp is added on the PCB board.

Advantage: The reflecting cover, which highly reflects light, is installed on a PCB board. The PCB board except the LED is shielded. The view is beautiful and concise. The loss of light is reduced; A part of light emitted by the LED is controlled to emit downwards, then through the glass cover or the PC lampshade, more light is emitted downwards, so that the ratio of the effective light of the effective output of 0-90 degrees is more than 90%, the light efficiency of 0-90 degrees is larger than or equal to 120 lm/w, the high light efficiency of the effective light part of 0-90 degrees is perfectly realized; The requirement standard that the light efficiency of the effective light part of 0-90 degrees is larger than or equal to 120 lm/w, which is in the high level standard of the DLC energy efficiency, is satisfied, improving the competitiveness and the energy-saving effect of the product.

The process of formation: the reflecting cover is added, so that the inclination of the PCB can be reduced, the processing difficulty is reduced; next, more light is emitted downwards, so that the ratio of the effective light of the effective output of 0-90 degrees is more than 90%, the light efficiency of 0-90 degrees is larger than or equal to 120 lm/w, the high light efficiency of the effective light part of 0-90 degrees is perfectly achieved; The requirement standard that the light efficiency of the effective light part of 0-90 degrees is larger than or equal to 120 lm/w, which is in the advanced standard of DLC energy efficiency standard, is satisfied, so that under the same condition, the vertical illumination is excellent, and the effective light efficiency of the lamp is improved, the market demand can be better met, the competitiveness and the energy-saving effect of the product are improved.

The LED wall lamp of this invention is mainly used for the optical structure design of wall lamps in the following situations: wall installation, park, plaza, and all situations where the following goals are achieved through advanced LED optical design: the consistency is high, the vertical illumination is excellent, and the distance visibility of the light source is reduced (the light source is invisible at the position far away from the lamp).

The above are only preferred embodiments of the present invention, and are not intended to limit the scope of the present invention. Any equivalent structure or equivalent process conversion made by using the specification and the drawing content of the invention, or direct or indirect application to other related technical fields, is similarly included in the protection scope of the invention.

What is clamed is:

1. An optical structure of LED wall lamps with enhanced effective output light, wherein the optical structure is arranged on an outer shell of the LED wall lamp, and the LED wall lamp comprises: a bottom shell, a radiator lamp body, a light source module and a surface cover; wherein the bottom shell is configured to be connected with the radiator lamp body; wherein a left side surface and a right side surface of the radiator lamp body respectively comprises triangular surfaces, with the triangular surfaces being connected with rectangle surfaces; wherein a mounting groove is configured to be arranged on one of the rectangular surfaces; wherein a light source module is configured to be arranged in the mounting groove; wherein the light source module comprises a PCB lamp board; wherein LED lamp beads are configured to be affixed on the PCB lamp board and are aligned as multi-row horizontal straight lines; wherein a reflecting cover is configured to be arranged on the PCB board; wherein a reflecting cover is configured to shield the PCB lamp board except the LED lamp beads; wherein an upper reflecting surface and a lower reflecting surface of the reflecting cover is configured to reflect output light reflected by LED lamp beads in directions in a range of 0-90 degrees;
wherein the reflecting cover and the light source module are configured to be fixed to the radiator lamp body through a third screw to form a heat dissipation assembly; wherein a pressing piece is configured to affix a glass surface mask and the waterproof rubber ring on the radiator; wherein a second screw is configured to pass through a middle hole of the pressing piece to lock the pressing piece on the radiator lamp body; wherein a surface cover is configured to cover the pressing piece, and is configured to be fixed on the radiator through a set screw which is located on a side;
wherein an inclination angle of 5-30 degrees is configured to be set between a bottom surface of the installation groove and the radiator lamp body, and a distance from the bottom surface to the radiator lamp body is configured to increase from a top to a bottom;
wherein the reflecting cover comprises a plurality of rows of trapezoid-shaped grooves, wherein an upper end and a lower end of the trapezoid-shaped groove comprises hole openings, wherein an angle between an upper inclined side surface and a bottom surface is smaller than an angle between a lower inclined side surface and the bottom surface, and wherein a left side surface and a right side surface are inclined.

2. The optical structure of LED wall lamps of claim 1, wherein a bottom shell has a square body and has an opening in an upper end; wherein the radiator lamp body is configured to cover the opening and is connected through a third screw; wherein the radiator lamp body comprises two triangular side plates and two square-shaped inclined planes which are connected with the two triangular side plates; wherein the bottom surface of the radiator lamp body has a square opening; wherein the bottom surface of the radiator lamp body is connected with the opening in the upper end of the bottom shell; wherein an installation groove is arranged on one inclined plane of the radiator lamp body; wherein a light source module is arranged on an inner bottom surface of the mounting groove; wherein the reflecting cover is configured to cover the light source module, and a third screw is configured to affix the reflecting cover and the light source module on the mounting groove of the radiator lamp body to form a heat dissipation assembly.

3. The optical structure of LED wall lamps of claim 1, wherein a waterproof frame is arranged at the joint between the radiator lamp body and the bottom shell.

4. The optical structure of LED wall lamps of claim 1, wherein the light source module comprises a light source plate and a plurality of LED light sources, and wherein the LED light sources are affixed on the light source plate and are aligned as multi-row horizontal straight lines.

5. The optical structure of LED wall lamps of claim 1, wherein the reflecting cover is installed on the PCB board of the light source module; wherein the reflecting cover is configured to shield the PCB board body except the LED lamp; wherein a triangular protrusion thereon is arranged in a light-emitting region of the LED lamp and its angle enables reflecting light emitted by the LED lamp and parallel light beams formed from the reflection of the light of 0-120 degrees emitted by LED lamp are within a range of 0-90 degrees.

6. The optical structure of LED wall lamps of claim 1, wherein the glass surface mask is protruded out of the inclined surface of the radiator lamp body; wherein the glass surface mask has two side surfaces that are triangular, two upper surfaces that are inclined surfaces, and a whole outer surface with rhombohedral concave-convex patterns.

7. The optical structure of LED wall lamps of claim 6, wherein the rhombohedral concave-convex patterns are all transversely arranged on the glass mask.

8. The optical structure of LED wall lamps of claim 1, wherein the glass mask is replaceable with a PC mask.
